(19) United States
(12) Patent Application Publication
(10) Pub. No.: US 2017/0099701 A1
(43) Pub. Date: Apr. 6, 2017

(54) LADDER WITH HEATED RUNGS

(71) Applicant: JAKE ROBERT FERNANDEZ, NASSAU, NY (US)

(72) Inventor: JAKE ROBERT FERNANDEZ, NASSAU, NY (US)

(21) Appl. No.: 14/873,812

(22) Filed: Oct. 2, 2015

(51) Int. Cl. H05B 3/44; H05B 3/04; F28D 1/047; H05B 3/02; E06C 5/02; E06C 5/44

(52) U.S. Cl. CPC H05B 3/44; E06C 5/02; E06C 5/44; F28D 1/0477; H05B 3/026; H05B 3/04

(57) ABSTRACT

A ladder is described. The ladder includes a plurality of rungs. A heating element is coupled to at least one rung of the plurality of rungs. A power supply provides current to the heating element to generate heat. A portion of the heat is transferred to the at least one rung. The heating element can be located at least partially inside the rung. The power supply can be located remotely from the ladder.

### CROSS REFERENCE TO RELATED APPLICATION

The present application is related to and claims the benefit of priority under 35 U.S.C. §119(e) from U.S. Provisional Application Ser. No. 62/059,413, filed Oct. 3, 2014, the entire contents of which are incorporated herein by reference.

### TECHNICAL FIELD

This invention relates to a ladder such as a ladder used on a fire truck. The ladder includes rungs that can be heated.

### BACKGROUND OF THE INVENTION

It is known to manufacture ladders using a plurality of horizontal rungs which are attached to one or more vertical supports. In cold environments, the horizontal rungs can get slippery as snow and ice form on them. This can lead to a dangerous condition for a person climbing up or down the ladder.

### SUMMARY

In one aspect, the invention is embodied in a ladder. The ladder includes a plurality of rungs. A heating element is coupled to at least one rung of the plurality of rungs. A power supply provides current to the heating element to generate heat. A portion of the heat is transferred to the at least one rung. In one embodiment, the rungs are fabricated from a material that conducts heat.

The heating element can be located at least partially inside the at least one rung. In one embodiment, the heating element is an electrical filament. The rung can be substantially tubular in shape.

In one embodiment, the power supply is integrated with a ladder truck. In another embodiment, the power supply can be integrated with the ladder. In yet another embodiment, the power supply is located remotely from the ladder. The ladder can also include a pair of longitudinal supports for supporting the plurality of rungs.

In another aspect, the invention is embodied in a ladder having an alternate configuration. The ladder includes a plurality of rungs. A fluid is located inside at least one rung of the plurality of rungs. A heater is operative to provide heat to the fluid. A portion of the heat is transferred to the at least one rung.

In one embodiment, the rungs are fabricated from a material that conducts heat. The fluid can include oil, antifreeze, and/or water. In one embodiment, the heater is a radiator. A coil can be located at least partially within the rung for containing the fluid. In one embodiment, the heater is the engine of a ladder truck. In this embodiment, the engine heats antifreeze and a water pump circulates the heated antifreeze through a coil passing through the rungs of the ladder. A pair of longitudinal supports can support the plurality of rungs.

In another aspect, the invention is embodied in a method of heating the rungs of a ladder. The method includes coupling a heat source to a rung of the ladder. The method also includes activating the heat source to generate heat such that at least a portion of the heat is transferred to the rung of the ladder.

In one embodiment, the heat source includes an electrical heating element and the step of activating the heat source includes providing electrical power to the electrical heating element. In another embodiment, the heat source includes a fluid and the step of activating the heat source includes heating the fluid. In yet another embodiment, the heat source includes steam and the step of activating the heat source includes generating the steam.

### BRIEF DESCRIPTION OF THE DRAWINGS

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 is a side view of a fire engine having an extension ladder according to the invention;

FIG. 2 is a partial, cross-sectional view of a ladder according to the invention;

FIG. 3 is a partial, cross-sectional view of alternative ladder according to the invention;

FIG. 4 is a partial, cross-sectional view of alternative ladder according to the invention; and

FIG. 5 is a perspective view of an extension ladder according to the invention.

### DESCRIPTION OF PREFERRED EMBODIMENTS

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to conventional plant hangers, need not, and are not, described in detail herein.

Techniques and technologies may be described herein in terms of functional components and various processing steps. It should be appreciated that such components may be realized by any number of hardware components configured to perform the specified functions.

The following description may refer to elements or features being “connected” or “coupled” together. As used herein, unless expressly stated otherwise, “connected” means that one element/feature is directly joined to (or directly communicates with) another element/feature. Likewise, unless expressly stated otherwise, “coupled” means that one element/feature is directly or indirectly joined to (or directly or indirectly communicates with) another element/feature. The term “exemplary” is used in the sense of “example, instance, or illustration” rather than “model,” or “deserving imitation.”

Technologies and concepts discussed herein relate to ladders having rungs that can be heated. In an exemplary embodiment, a ladder includes a plurality of rungs. A heat source is coupled to one or more of the rungs. A power supply provides current to the heat source. The heat source can be an electrical filament, for example. Alternatively, the heat source can be a coil containing a heat conducting liquid such as oil. In one embodiment, the heat source can be steam.

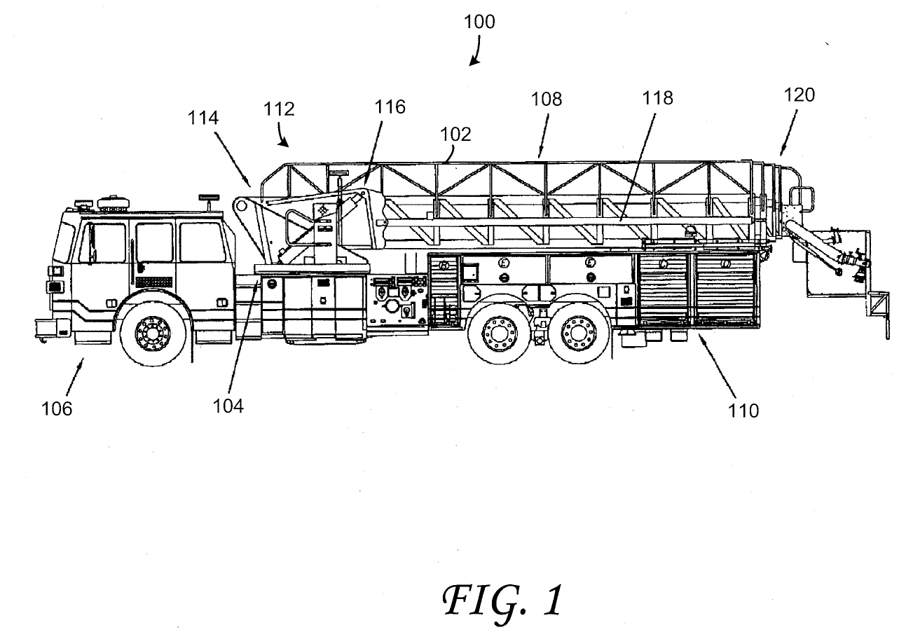

FIG. 1 is a side view of a fire engine 100 having an extension ladder 102 according to the invention. The extension ladder 102 attached to a rotatable turntable 104. The fire engine 100 also includes a forward portion 106 comprising substantially a cab and an engine and front axle, and a rearward portion 108 that comprises, among other things, the rear axle or axles, a water reservoir, a water pump; and storage areas 110. The cab of the fire engine 100 can transport passengers, as is common to such equipment. The pump may be adapted to pump water from the onboard water reservoir and also from a pressurized water supply, such as, for example, a fire hydrant (not shown).

A center portion 112 of the fire engine 100 is defined to exist between the forward portion 106 and the rearward portion 108 of the fire engine 100, and preferably between the front and rear axles. The turntable 104 is located substantially at the center portion 112 of the fire engine 100. The extension ladder 102 may be mounted to the turntable 104. More specifically, a proximal end of the extension ladder 102 is preferably secured to the turntable 104 by a ladder support structure 114. By locating the extension ladder 102 and its associated mounting structures between the forward portion 106 and the rearward portion 108, those portions are able to contribute significantly to the longitudinal stability of the fire engine 100 while the extension ladder 102 is in use.

The extension ladder 102 of the fire engine 100 of the present invention is adapted to be rotated through substantially a 360 degree arc by the turntable 104. The extension ladder 102 is also equipped with a hydraulic lifting system 116 that allows it to be raised from a stored, substantially horizontal position (as shown in FIG. 1) to a substantially vertical position (not shown). The extension ladder 102 is also equipped with an extension system 118 of hydraulic cylinders and cables that allow each of its sections 120 to be extended so that the ladder 102 can be made increasingly longer in length. Additionally, the fire engine 100 allows the extension ladder 102 to be rotated fully through its 360 degree range of rotational motion, with the ladder 102 fully extended and positioned at substantially any angle between horizontal and vertical.

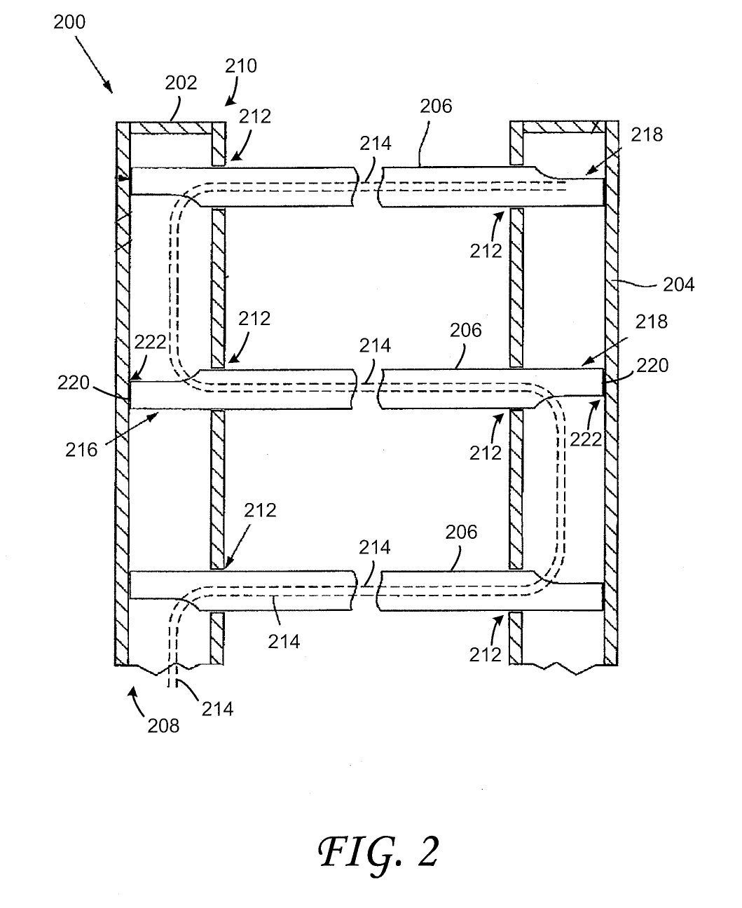

FIG. 2 is a partial, cross-sectional view of a ladder 200 according to the invention. The ladder 200 has a first vertically extending, elongated support 202, a second vertically extending, elongated support 204 which is spaced from the first support 202 and which opposes the first support 202, and a plurality of horizontally extending, elongated rungs 206, each of which extends between the first and second supports 202, 204.

The supports 202, 204 can be any suitable shape, such as tubular, rectangular, U-beam, I-beam, or L-beam, for example. The rungs 206 can also be any suitable shape, such as tubular, rectangular, for example. In the example shown, the supports 202, 204 and rungs 206 are circular in cross-section. The supports 202, 204 and rungs 206 are fabricated from any appropriate material that can conduct heat such as aluminum or stainless steel.

Each of the supports 202, 204 extend from a bottom end 208 to a top end 210 and can be sealed at the ends 208, 210. Each support 202, 204 includes a plurality of openings 212 formed therein. The number of openings 212 correspond to the number of rungs 206 of the ladder 200 and are formed in the side of the supports 202, 204. The openings 212 in the first support 202 face towards the respective openings 212 in the second support 204. Each opening 212 is dimensioned so that a rung 206 fits snugly therethrough. The rungs 206 are spaced apart in any appropriate configuration between the supports 202, 204 and generally are positioned one on top of the other from the bottom end 208 to the top end 210.

An elongated, flexible electrical heating element 214 is at least partially threaded through the first and second supports 202, 204 and the rungs 206 in a serpentine manner. In practice, the heating element 214 can be threaded through the first and second supports 202, 204 and the rungs 206 in any suitable manner. The end of the heating element 214 is connected to an electricity supply (not shown). In one embodiment, the electrical supply is incorporated in a ladder truck. For example, the heating element 214 can be coupled to an electrical generator in the ladder truck. Alternatively, the heating element 214 can be coupled to a portable electrical power supply, such as a battery or a portable generator. Skilled artisans will appreciate that a switch (not shown) can be coupled between the heating element 214 and the power supply. In one embodiment, the switch can be automatically triggered by a sensor (not shown). For example, the sensor can activate the switch when the ambient temperature falls below freezing and/or when the sensor detects snow or ice forming.

In one embodiment, the heating element 214 heats the supports 202, 204 and the rungs 206. In another embodiment, the heating element 214 is fabricated such that only electrical wires are threaded through the supports 202, 204 and the heating element 214 only heats the rungs 206 and not the supports 202, 204. In this embodiment, the supports 202, 204 may still receive some indirect heat conducted from the heated rungs 206. Skilled artisans will appreciate that the rungs 206 can be fabricated from any suitable material that conducts heat, such as metal, for example.

The ladder 200 is manufactured by cutting appropriate lengths of supports 202, 204. The opposing ends of each support 202, 204 can be plugged and sealed. The appropriately spaced openings 212 for the rungs 206 are located in each support 202, 204. Appropriate lengths of rungs 206 are cut and the respective ends 216, 218 of each rung 206 is appropriately shaped to form an abutment surface 220.

The ladder 200 is assembled by passing the respective first and second ends 216, 218 of each rung 206 through opposing openings 212 in the first and second supports 202, 204. The abutment surface 220 of each end 216, 218 is brought into abutment with each respective inner surface 222 of the support 202, 204. The rungs 206 can be fixed to the supports 202, 204 be any suitable technique. For example, the rungs 206 can be fixed to the supports 202, 204 by using hardware or by welding. In one embodiment, the element 214 is threaded through the supports 202, 204 and rungs 206 as the ladder 200 is being assembled.

The shape between the abutment surface 220 and the inner surface 222 provides stability to the ladder 200 and the openings 212 allow the element 214 to pass freely though the course defined by the supports 202, 204 and the rungs 206.

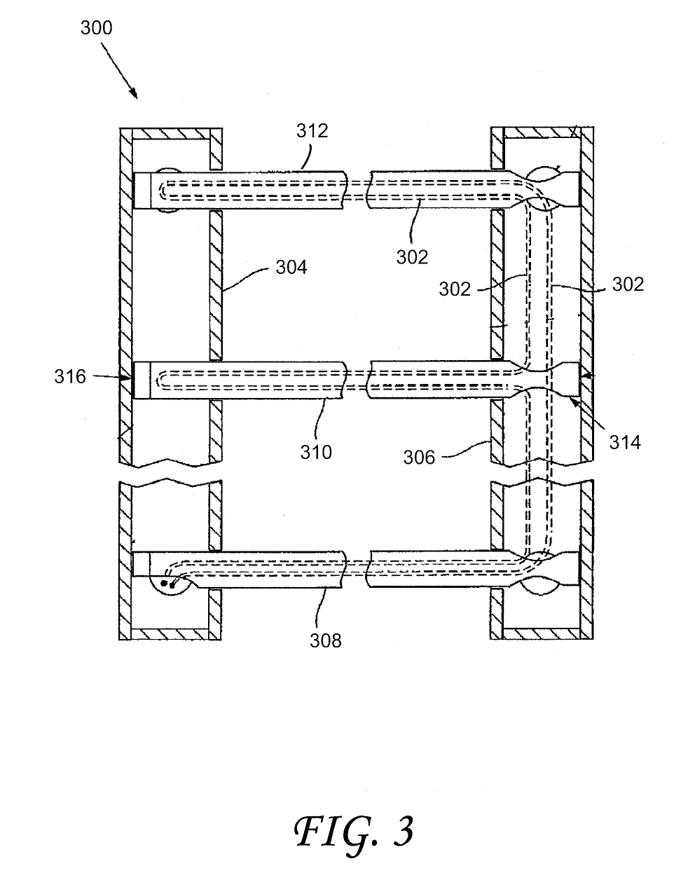

FIG. 3 is a partial, cross-sectioned side view of alternative ladder 300 according to the invention. In this embodiment, the heating element 302 is not threaded through the supports 304, 306 and rungs 308, 310, 312 in a zigzag pattern but instead extends through the lowermost rung 308 and the second support 306 from where it loops into each of the remaining rungs 310, 312.

During assembly of the ladder 300 the element 302 is threaded through the second support 304 and appropriate lengths of the element 302 are looped through each opening 314. Each looped section is threaded through a rung 310, 312 with the element 302 extending to the second end 316 of the rung 310, 312. The element 302 is pulled through the opening in each rung 310, 312 in order for it to be located in each rung 310, 312.

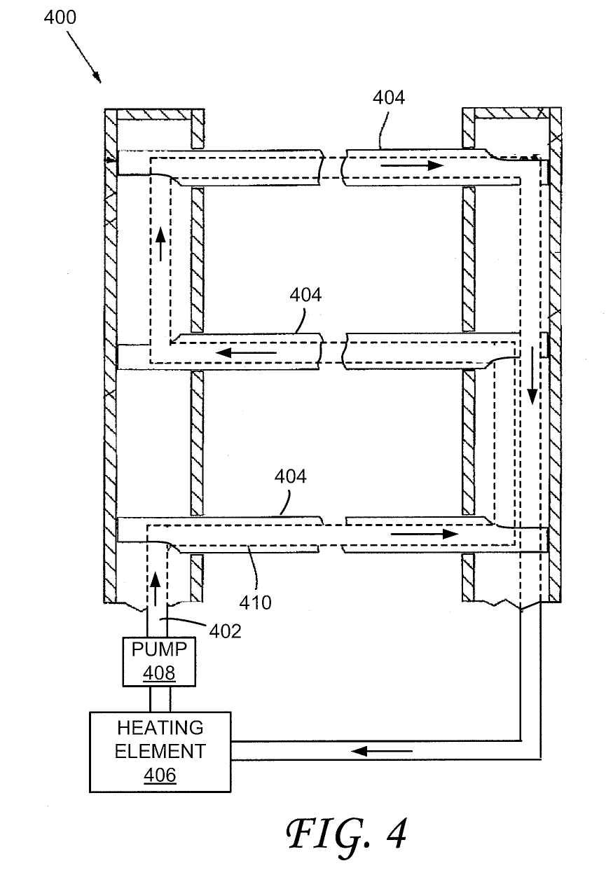

FIG. 4 is a partial, cross-sectioned side view of alternative ladder 400 according to the invention. In this embodiment, heated liquid 402 is used to heat the rungs 404 of the ladder 400. Any suitable liquid can be used, such as water, antifreeze, or oil, for example. In this embodiment, a heating element 406 located remotely from the ladder 400 can heat the liquid 402. A circulating pump 408 circulates the heated liquid through a coil 410 containing the liquid 402. In one embodiment, an antifreeze mixture from the radiator (not shown) of a ladder truck 100 (FIG. 1) can be circulated through the coil 410 located within the rungs 404. In this embodiment, heat from the engine (not shown) of the ladder truck 100 heats the antifreeze and a portion of that heat is transferred to the rungs 404. In one embodiment, the engine heats the antifreeze and a water pump circulates the heated antifreeze through a coil 410 passing through the rungs 404 of the ladder 400.

The coil 410 can be fabricated from any suitable material, such as copper, for example. The coil 410 can be threaded through each rung 404 of the ladder 400. Skilled artisans will appreciate that, in an alternate embodiment, steam could also be passed through the coil 410 in order to heat the rungs 404 of the ladder 400.

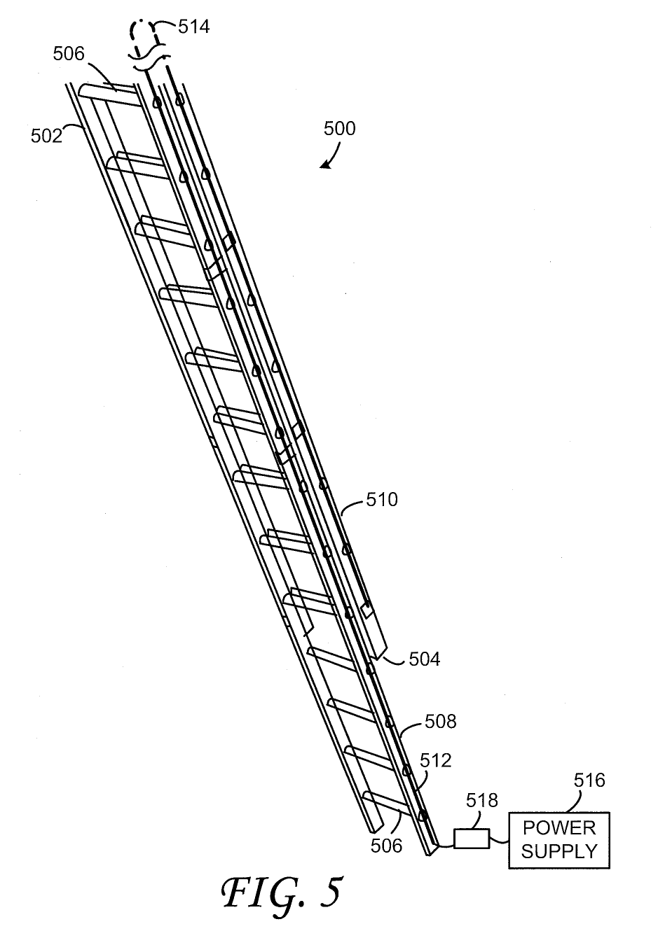

FIG. 5 is a perspective view of an extension ladder 500 according to the invention. The extension ladder 500 includes two sections 502, 504 which are coupled together such that they can slide relative to each other. The extension ladder 500 also includes a plurality of rungs 506. The rungs 506 are coupled to vertical supports 508, 510.

In one embodiment, a cable 512 is positioned along one of the vertical supports 508. In practice, the cable 512 can be hidden within the first vertical support 508. The cable 512 is sufficiently long to cover the length of the two sections 502, 504. A loop 514 in the cable 512 is provided in order to permit the two sections 502, 504 to move relative to each other. Skilled artisans will appreciate that, in practice, the cable 512 can be routed along the first vertical support 508 differently than shown in FIG. 5. For example, in practice, the loop 514 of the cable 512 can be located below the second vertical support 510 (not shown).

The cable 512 can be coupled to a plurality of heating elements (not shown) that are located in the rungs 506 of the ladder 500. Skilled artisans will appreciate that the cable 512 can be fabricated with heating elements located serially along the length of the cable 512, such that the cable can be threaded in a serpentine manner though the rungs 506.

The cable 512 is coupled to a power supply 516. In one embodiment, a switch 518 can be coupled between the cable 512 and the power supply 516. For example, the power supply 516 can be portable power supply, such as a generator or battery. In one embodiment, the power supply 516 is part of the power system of a ladder truck (not shown).

In another embodiment (not shown), a cable-less power scheme is used. For example, a power strip can be located on a track located along the length of the first vertical support 508. The power strip can be hidden so it cannot be easily accessed by a user. The power strip is connected to the external power supply 518. The power strip supplies energy to heating elements (not shown) located in the rungs corresponding to the first vertical support 508. Contact points, such as pogo pins or leaf springs, can be located on the lower end of the second vertical support 510. The contact points are coupled to a power strip located on the second vertical support 510. The power strip supplies energy to heating elements (not shown) located in the rungs corresponding to the second vertical support 510. The contact points located on the second vertical support 510 can contact the power strip located on the first vertical support 508. Power is transferred from the power strip located on the first vertical support 508 to the power strip located on the second vertical support 510 through the contact points. This power scheme ensures that power is provide to the heating elements located in the rungs corresponding to the second vertical support 510 regardless of the relative position of the sections 502, 504.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item implemented structure or function;
e) any of the disclosed devices or portions thereof may be combined together or separated into further portions unless specifically stated otherwise; and
f) no specific sequence of acts or steps is intended to be required unless specifically indicated.

What is claimed is:

1. A ladder, comprising:
a plurality of rungs;
heating element coupled to at least one rung of the plurality of rungs; and
a power supply operative to provide current to the heating element to generate heat, at least a portion of the heat being transferred to the at least one rung.

2. The ladder of claim 1, wherein the at least one rung is fabricated from a material that conducts heat.

3. The ladder of claim 1, wherein the heating element is located at least partially inside the at least one rung.

4. The ladder of claim 1, wherein the heating element comprises an electrical filament.

5. The ladder of claim 1, wherein the at least one rung is substantially tubular in shape.

6. The ladder of claim 1, wherein the power supply is integrated with a ladder truck.

7. The ladder of claim 1, wherein the power supply is integrated with the ladder.

8. The ladder of claim 1, wherein the power supply is located remotely from the ladder.

9. The ladder of claim 1, further comprising a pair of longitudinal supports for supporting the plurality of rungs.

10. A ladder comprising:
a plurality of rungs;
a fluid located inside at least one rung of the plurality of rungs; and
a heater operative to provide heat to the fluid, at least, a portion of the heat being transferred to the at least one rung.

11. The ladder of claim 10, wherein the at least one rung is fabricated from a material that conducts heat.

12. The ladder of claim 10, wherein the fluid comprises at least one of oil, antifreeze, and water.

13. The ladder of claim 10, wherein the heater comprises a radiator.

14. The ladder of claim 10, wherein the heater comprises an engine of a ladder truck.

15. The ladder of claim 10, further comprising a coil located at least partially within the at least one rang for containing the fluid.

16. The ladder of claim 10, further comprising a pair of longitudinal supports for supporting the plurality of rungs.

17. A method comprising:
coupling a heat source to at least one rung of a ladder; and
activating the heat source to generate heat such that at least a portion of the heat is transferred to the at least one rung.

18. The method of claim 17, wherein the heat sources comprises an electrical heating element and activating the heat source comprises providing electrical power to the electrical heating element.

19. The method of claim 17, wherein the heat source comprises a fluid and activating the heat source comprises heating the fluid.

20. The method of claim 17, wherein the heat source comprises steam and activating the heat source comprises generating the steam.
